(19) United States
(12) Patent Application Publication
(10) Pub. No.: US 2025/0050667 A1
(43) Pub. Date: Feb. 13, 2025

(54) Numbering Unit with Variable Print Wheel Width

(71) Applicant: ZEISER GmbH, Emmingen-Liptingen (DE)

(72) Inventor: Oliver Kostenbader, Tuttlingen (DE)

(21) Appl. No.: 18/044,359

(22) PCT Filed: Sep. 10, 2021
(86) PCT No.: PCT/DE2021/100752

§ 371 Date: Oct. 23, 2024

(30) Foreign Application Priority Data
Sep. 10, 2020 (DE) 10 2020 123 682.4

(51) Int. Cl. B41K 3/12

(52) U.S. Cl. CPC B41K 3/126

(57) ABSTRACT

The invention relates to a numbering unit (10) with type wheels (16) for applying a character string to a document, wherein the type wheels (16) are mounted rotatably about an axis of rotation (162), and wherein a catch (20) is assigned to a type wheel (16) in order to prevent undesired rotation of the type wheel (16), wherein the catch (16) is displaceable along the axis of rotation (162) of the type wheels (16). Furthermore, the invention relates to a catch (20) for such a numbering unit (10), and to a numbering machine with such a numbering unit (10). The present invention thus provides a numbering unit (10) with a variable type wheel width, since the catches (20) can be adjusted both to a different width and to a different number of type wheels (16).

The present invention relates to a numbering unit according to the preamble of claim 1, accordingly to a numbering unit with type wheels for applying a character string to a document, wherein the type wheels are mounted rotatably about an axis of rotation, and wherein a catch is assigned to a type wheel in order to prevent undesired rotation of the type wheel.

The invention further relates to a catch for a numbering unit according to claim 26, and to a numbering machine according to claim 27.

Numbering units are generally known from EP 0 718 112 A1, DE 295 01 349 U1, DE 44 46 273 A1, DE 10 2006 052 183 A1 and DE 10 2011 100 847 A1, among others.

Such numbering units are used in particular for applying, and in particular printing, a security feature on security documents. In this context, the numbering unit can also be referred to as a numbering printing unit or a printing unit.

In particular, known numbering units are used to apply serial numbers to security documents, in particular banknotes.

In a common arrangement, a numbering unit is arranged on a mounting ring of a numbering machine (printing machine) in a reversible manner, i.e. fixed but can be released again if desired. The numbering unit is located on the outside of the mounting ring, and the type wheels of the unit are arranged on the side which is facing away from the mounting ring. The mounting ring is generally arranged on a numbering shaft of the numbering machine. Furthermore, the numbering units are located on the outside of the mounting ring.

The sheet to be printed (in particular a sheet of paper with banknotes to be numbered) is then fed to the numbering machine. In the numbering machine, the mounting ring with the numbering units fixed to the outside of the ring rolls on the sheet to be printed, whereby the individual security documents are each provided with a security feature, in particular a serial number, by the individual numbering units. The character string which is applied to the document corresponds to the character string which is defined by those types of the adjacently arranged type wheels which are momentarily arranged next to each other on the upper side of the numbering unit.

A plurality of mounting rings per numbering shaft and a plurality of numbering units per mounting ring, namely distributed around the circumference of the mounting ring, are generally provided. This is known per se and is not the subject of the present invention.

The numbering unit can be divided into two parts and have an upper part and a lower part. In particular, the lower part can be fixed to the mounting ring by clamping, but may be detachable again.

The lower part of the numbering unit may remain on the mounting ring and only the upper part needs to be removed and replaced, if necessary. This means that the position of the numbering unit on the mounting ring remains unchanged and the clamping between the numbering unit and the mounting ring does not need to be loosened.

On the other hand, removing the lower part of the unit from the mounting ring for the purpose of replacing a numbering unit is disadvantageous and should be avoided, as the positioning of the lower part on the mounting ring has to be carried out with the smallest tolerances. In this respect, replacing the entire numbering unit would take an unacceptable amount of time.

There also exist both vertical and horizontal numbering units. A vertical numbering unit applies a character string to the document that extends in the circumferential direction of the mounting ring. A horizontal numbering unit applies a character string to the document that extends perpendicular to the circumferential direction of the mounting ring.

The numbering unit or the upper part of the numbering unit generally comprises the type wheels and the entire numbering mechanism, which in itself is known in the art. These parts must generally be designed to be quickly removable from the mounting ring, so that the numbering machine does not have to be shut down for too long if the numbering mechanism needs to be replaced, e.g. in the event of defects, wear or a change to the print job.

In general, numbering units also have a mechanism that advances the preset serial number by one unit at a desired digit of the number after each printing process, or each time the unit and mounting ring rotate, so that the next document can be printed with a vacant or subsequent serial number. To achieve this, the respective type wheel of the numbering unit is usually rotated by one position. This is in itself known in the art.

So-called catches are known to prevent unwanted changes in the position of the type wheels during the setting process or the printing process. These catches are tiltably mounted relative to the type wheel and engage with their respective ends in suitable recesses in the type wheel in order to prevent the type wheel from turning.

Such a catch generally prevents a type wheel from turning back (to a lower number) completely due to the establishing of a form closure. On the other side, a certain holding force must be overcome by the above-mentioned numbering mechanism in order for the type wheel to continue to rotate as desired. If this force is reached, the end of the catch which is close to the type wheel swivels upwards and allows the type wheel to continue turning.

Once the next position is reached, the catch engages in the next suitable recess of the type wheel and thus stabilizes the current position of the wheel again. The presence of such catches in numbering units is generally regarded as indispensable in order to achieve an acceptable printing result.

It is also known in the art that the type wheels of existing numbering units may be exchanged or replaced, depending on the required number set or font set. So far, however, the type wheels can only be replaced with wheels of the same width. This is due to the fact that in previously known numbering units, the position of the catches arranged between adjacent type wheels is predetermined by slots in the housing, by separate spring bars, or the like, into which the catches are inserted in or in which they are running.

Thus, according to the state of the art, the wheel width, and thus the font width, cannot be changed, even if the type wheels are replaced. This means that there exists no variability in this respect, and a large number of different numbering units have to be purchased.

The present invention is based on the problem of overcoming the disadvantages known from the prior art. Furthermore, the problem is to provide a numbering unit with variable type wheel width.

In relation to a numbering unit, this problem is solved by the characterizing features of claim 1. Accordingly, in the numbering unit according to the invention, it is provided that the catch is displaceable along the axis of rotation of the type wheels.

A catch for such a numbering unit according to the invention is described with the features of claim 26.

A numbering machine according to the invention with such a numbering unit is described with the features of claim 27.

Advantageous embodiments and further developments of the invention are the subject of the respective dependent patent claims.

The invention is based on the idea of designing the catches to be displaceable and adjustable along the type wheel set, i.e. along the axis of rotation of the type wheels.

A displacement along the axis of rotation of the type wheels relates in particular to a displacement in a direction that is oriented parallel to the axis of rotation of the type wheels.

This means that a catch can be adjusted to any type wheel width by moving it along the axis of rotation of the type wheel until it engages in the recesses provided in the type wheel.

This means that the catches of the numbering unit can be adjusted to any type wheel set, i.e. to type wheels of any width.

Such a catch is another object of the invention.

Another object is a numbering unit with such an adjustable catch.

Said numbering unit preferably comprises interchangeable type wheels.

Another object of the invention is a numbering machine with an aforementioned numbering unit.

In the following, the aspects of the invention are discussed further, for which reference is made in part to non-limiting advantageous embodiments and further developments of the invention. The features of advantageous further developments can be implemented individually or in any combination, whereby further advantageous embodiments of the invention are created.

Preferably, a character string is printable on a document by the type wheels of the numbering unit, i.e. the application of a character string preferably comprises the printing of a character string.

A preferred embodiment of the invention relates to a numbering unit in which the type wheels are interchangeable.

Preferably, the type wheels are arranged next to each other along the axis of rotation in the numbering unit and form a type wheel set.

The numbering unit preferably comprises a numbering mechanism.

The numbering mechanism is preferably set up in such a way that a character string set on the type wheels is advanced by one unit after each printing process at a desired digit of the character string.

In the numbering unit, a catch can be arranged between two adjacent type wheels.

Preferably, the catch can extend essentially tangentially from a space between two adjacent type wheels onto the outside of the type wheel set.

In a further advantageous development, a catch is mounted tiltably relative to a type wheel.

It is particularly preferred that the catch is set up so that it engages with one end in a recess in the type wheel or between adjacent type wheels in order to prevent unwanted rotation of the type wheel.

In an advantageous way, the catch can be set up in such a way that it prevents the type wheel from turning back to a lower character by establishing a form closure.

The catch can also preferably be set up in such a way that it exerts a holding force on the type wheel, which force may be overcome by a numbering mechanism in the sense of a desired further rotation of the type wheel.

In a further preferred manner, the catch can be set up in such a way that when the holding force is overcome, one end of the catch close to the type wheel swivels upwards in relation to the type wheel and allows the type wheel to rotate further.

It is also advantageous if existing catches can be removed from the numbering unit and/or additional catches can be added to the numbering unit. If, for example, the type wheel set is replaced by wheels of twice the width, only half of the type wheels can be inserted into the numbering unit without changing the housing, and vice versa. It is therefore advantageous to be able to remove surplus catches or add additional catches, as required.

It is particularly preferred that a catch can be adjusted to any type wheel width by displacing it along the axis of rotation of the type wheels.

In a specific advantageous embodiment, the catch is displaceably mounted on an axle that extends parallel to the axis of rotation of the type wheels.

Such an axle can preferably simultaneously provide a tilting axis for the catch.

A catch can advantageously be set up in such a way that it is subjected to a spring force at an end facing away from the type wheel, which causes an end of the catch facing the type wheel to be pressed against the type wheel.

In a preferred further development, a compression spring is arranged between one end of the catch facing away from the type wheel and the numbering unit.

Such a compression spring can preferably be implemented in a spring pin.

One end of a catch facing away from the type wheel can be advantageously supported in a fork. This allows lateral stability of the catch to be achieved, as a fixed guide of the catch by the housing or a spring bar, as in the prior art, is not possible.

Such a fork can preferably be formed or arranged at the end of a spring pin.

In another preferred embodiment, the spring pin can be moved together with the catch along the axis of rotation of the type wheels. This means that both the catch and a mechanism for applying pressure to the catch can be moved and adjusted together.

Preferably, one end of the spring pin facing the numbering unit is displaceably mounted in a groove or in a guide groove, in particular the end of the spring pin being displaceable along the axis of rotation of the type wheels.

It is also advantageous if two guide grooves are realized one above the other and if adjacent spring pins are each mounted in a different guide groove.

The numbering unit can preferably be removed from a lower part by releasing a separate clamping connection. On the other hand, the numbering unit can preferably be fixed by establishing a clamping connection to a lower part, in particular which is arranged on a mounting ring of a numbering machine.

The lower part mentioned is preferably reversibly attachable, in particular clampable, to a mounting ring of a numbering machine, and may remain on the mounting ring when the numbering unit is replaced.

Preferably, the lower part comprises a clamping lever with an opposing clamping hook, through the mutual tensioning of which the lower part can be fixed to a mounting ring. Screws preferably extend through the clamping hook into the lower part.

Preferably, the numbering unit comprises at least one, preferably two, more preferably two opposing, tensioning levers which, starting from the numbering unit, each extend into a suitable recess, undercut, groove or the like in a lower part, and can thus secure, fix or clamp the numbering unit to the lower part.

Alternatively or additionally, a lower part may comprise at least one, preferably two, more preferably two opposing, tensioning levers which, starting from the lower part, each extend into a suitable recess, undercut or the like in the numbering unit, and can thus fix the numbering unit to the lower part.

Preferably, at least one spring is arranged between a tensioning lever and the numbering unit, which pretensions the tensioning lever, and thus prevents the numbering unit from being released from a lower part when the tensioning lever is engaged.

### DRAWINGS

Supplementary or in addition to the advantageous embodiments and further developments of the teaching already discussed, further embodiments of the invention shown in the drawings to the extent of FIGS. 1 and 2 are explained in more detail below. However, the examples discussed with reference to the drawings do not limit the invention to the examples shown. In discussing the embodiments with reference to the drawings, generally preferred embodiments and further developments of the teaching are also shown.

Further developments of the advantageous embodiments described above with features of the embodiments described below, just like further developments of the embodiments described below with features of the embodiments described above, expressly form further advantageous embodiments of the invention, and thus form part of the present disclosure.

It is shown in:

FIG. 1 a preferred embodiment of the numbering unit according to the invention in a perspective view, and

FIG. 2 in a further perspective view comparing a preferred embodiment of the catch according to the invention with a catch according to the state of the art.

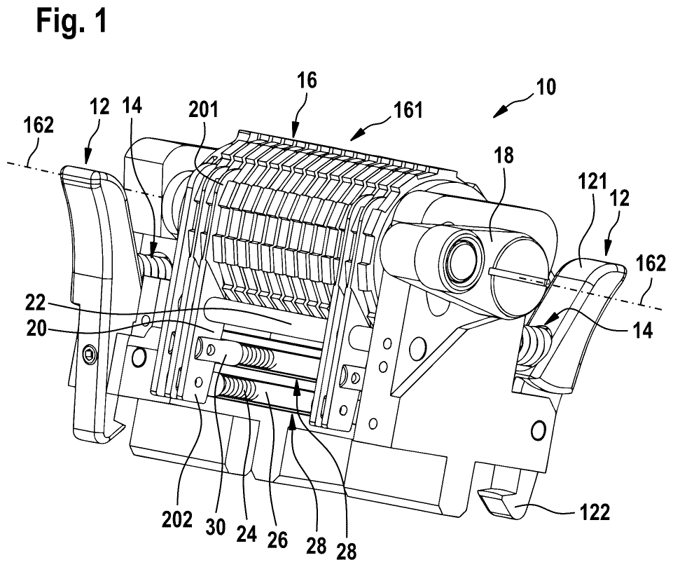

FIG. 1 shows a preferred embodiment of a numbering unit 10 according to the invention in a perspective view.

Alternatively, the numbering unit 10 shown could also be referred to as the upper part of a numbering unit 10 without departing from the idea of the invention.

The numbering unit 10 shown still requires a lower part or base in order to be fixed, preferably reversibly, on the mounting ring (not shown) of a numbering machine (not shown). Such a lower part or base is not shown here.

In the numbering unit 10, two tensioning levers 12 are tiltably arranged diagonally opposite each. The tensioning levers 12 extend essentially vertically and comprise an actuation section 121 at the top for the user and a hook section 122 at the bottom for engagement in a lower part.

At least one spring 14 acts between the numbering unit 10 and the tensioning lever 12, which pretensions the tensioning lever 12 in a suitable manner.

By actuating the tensioning lever 12 against the force of the spring 14, the user can pivot the tensioning lever 12 away from the lower part and thus remove the numbering unit 10 from the lower part very quickly. Conversely, the numbering unit 10 can in this way be advanced to the lower part and be arranged or engaged on it.

By withdrawing the actuating force on the tensioning levers 12, these then pivot into the lower part, and thus the numbering unit 10 is fixed and/or clamped to the lower part. This establishment of a connection between the numbering unit 10 and a lower part can also be carried out in a few seconds.

The type wheels 16 of the numbering unit 10 are arranged here so that they print a character string on the document (not shown) that extends perpendicular to the circumferential direction of the mounting ring (not shown). Therefore, this is a horizontal numbering unit 10.

The numbering unit 10 shown comprises the type wheels 16 and the entire numbering mechanism 18, which in itself is known in the art.

In order to avoid an undesired change regarding the position of the type wheels 16 during the adjustment process of the type wheels 16 and/or during the printing process itself, so-called catches 20 are provided. These are tiltably mounted relative to each type wheel 16 and engage with their respective end, namely with the end 201 close to the type wheel, in suitable recesses in a type wheel 16, or between the type wheels 16, in order to prevent the type wheel 16 from rotating.

In this case, the catches 20, starting from the space between two adjacent type wheels 16, extend essentially tangentially onto the outside of the type wheel set 161.

In the present numbering unit 10, the type wheels 16 are interchangeable, so that the font set can be changed. However, the wheel width, i.e. the width of a type wheel 16, and thus the font width or size, can also be changed here.

For this purpose, the catches 20 are designed to be displaceable and adjustable along the type wheels 16, i.e. along the axis of rotation 162 of the type wheels 16.

For this purpose, the catches 20 are displaceably mounted on an axle 22, which runs parallel to the axis of rotation 162 of the type wheels 16. This axle 22 also defines the tilting axis for the catches 20.

Each catch 20 is also subjected to a spring force at its end facing away from the type wheel 16, i.e. the end 202 remote from the type wheel, which causes the end 201 of the catch 20 facing the type wheel 16 to be pressed against the type wheel 16.

For this purpose, a compression spring 24 is arranged between the end 202 of the catch 20 facing away from the type wheel 16 and the inside of the numbering unit 10. This compression spring 24 is here implemented in a spring pin 26.

The ends of the spring pins 26 facing the numbering unit 10 are mounted in a groove or guide groove 28, wherein the respective end of a spring pin 26 is displaceable along the axis of rotation 162, in particular parallel to the axis of rotation 162, of the type wheels 16.

The end 202 of the catch 20 facing away from the type wheel 16 is supported in a fork 30.

Here, two guide grooves 28 are realized one above the other in order to provide more space for adjacent spring pins 26 in an alternating arrangement.

As a result, both the catch 20 and the mechanism described here can be moved and adjusted together with the spring pins 26 for applying pressure to the catch 20.

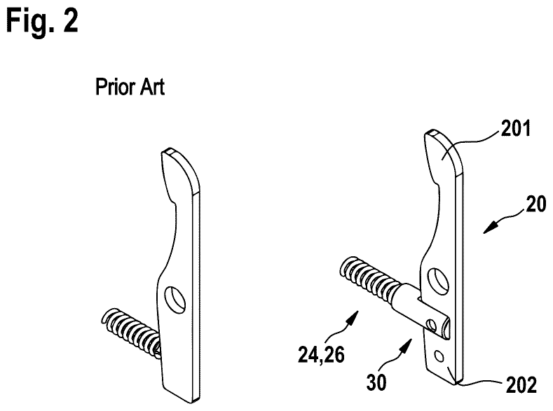

FIG. 2 shows a perspective view comparing a catch 20 according to the invention with a catch according to the prior art.

In the present case, the end 202 of the catch 20 facing away from the type wheel is supported in a fork 30, which is formed at the end of a spring pin 26. Thus, despite the lateral displaceability of the catch 20 according to the invention, an increased lateral stability of the catch 20 can be achieved.

### LIST OF REFERENCE SIGNS

10 numbering unit
12 tensioning lever
121 actuation section (tensioning lever)
122 hook section (tensioning lever)
14 spring
16 type wheel
161 type wheel set
162 rotary axis (type wheel)
18 numbering mechanism
20 catch
201 end of catch close to the type wheel/facing the type wheel
202 end of catch remote from the type wheel/facing away from the type wheel
22 axle (catch)
24 pressure spring
26 spring pin
28 guide groove
30 fork

1. Numbering unit (10) with type wheels (16) for applying a character string to a document, wherein the type wheels (16) are mounted rotatably about an axis of rotation (162), and wherein a catch (20) is assigned to a type wheel (16) in order to prevent undesired rotation of the type wheel (16),
characterized in that the catch (16) is displaceable along the axis of rotation (162) of the type wheels (16).

2. Numbering unit (10) according to claim 1, characterized in that a character string is printable on a document by the type wheels (16).

3. Numbering unit (10) according to claim 1 or 2, characterized in that the type wheels (16) are interchangeable.

4. Numbering unit (10) according to any one of claims 1 to 3, characterized in that the type wheels (16) are arranged next to each other along the axis of rotation (162) and form a type wheel set (161).

5. Numbering unit (10) according to any one of claims 1 to 4, characterized by a numbering mechanism (18).

6. Numbering unit (10) according to claim 5, characterized in that the numbering mechanism (18) is set up in such a way that a character string set on the type wheels (16) is advanced by one unit after each printing operation at a desired digit of the character string.

7. Numbering unit (10) according to any one of claims 1 to 6, characterized in that the catch (20) is arranged between two adjacent type wheels (16).

8. Numbering unit (10) according to any one of claims 1 to 7, characterized in that the catch (20) extends essentially tangentially onto the outside of the type wheel set (161), starting from a space between two adjacent type wheels (16).

9. Numbering unit (10) according to any one of claims 1 to 8, characterized in that the catch (20) is mounted tiltably relative to the type wheel (16).

10. Numbering unit (10) according to any one of claims 1 to 9, characterized in that the catch (20) is set up in such a way that it engages with one end (201) in a recess in the type wheel (16) or between adjacent type wheels (16) in order to prevent undesired rotation of the type wheel (16).

11. Numbering unit (10) according to any one of claims 1 to 10, characterized in that the catch (20) prevents the type wheel (16) from turning back to a lower character by establishing a form closure.

12. Numbering unit (10) according to any one of claims 1 to 11, characterized in that the catch (20) exerts a holding force on the type wheel (16), which force may be overcome by a numbering mechanism (18) in the sense of a desired further rotation of the type wheel (16).

13. Numbering unit (10) according to claim 12, characterized in that the catch (20) is set up in such a way that, when the holding force is overcome, an end (201) of the catch (20) close to the type wheel (16) swivels away upwards with respect to the type wheel (16) and releases the further rotation of the type wheel (16).

14. Numbering unit (10) according to any one of claims 1 to 13, characterized in that existing catches (20) can be removed from the numbering unit (10) and/or further catches (20) can be added.

15. Numbering unit (10) according to any one of claims 1 to 14, characterized in that the catch (20) is adjustable to any type wheel width by displacement along the axis of rotation (162) of the type wheels (16).

16. Numbering unit (10) according to any one of claims 1 to 15, characterized in that the catch (20) is displaceably mounted on an axle (22) which extends parallel to the axis of rotation (162) of the type wheels (16).

17. Numbering unit (10) according to claim 16, characterized in that the axle (22) simultaneously provides a tilting axis for the catch (20).

18. Numbering unit (10) according to any one of claims 1 to 17, characterized in that the catch (20) is subjected to a spring force at an end (202) facing away from the type wheel (16), which spring force causes an end (201) of the catch (20) facing the type wheel (16) to be pressed against the type wheel (16).

19. Numbering unit (10) according to any one of claims 1 to 18, characterized in that a compression spring (24) is arranged between an end (202) of the catch (20) facing away from the type wheel (16) and the numbering unit (10).

20. Numbering unit (10) according to claim 19, characterized in that the compression spring (24) is implemented in a spring pin (26).

21. Numbering unit (10) according to any one of claims 1 to 20, characterized in that an end (202) of the catch (20) facing away from the type wheel (16) is supported in a fork (30).

22. Numbering unit (10) according to claim 21, characterized in that the fork (30) is formed or arranged at the end of a spring pin (26).

23. Numbering unit (10) according to claim 20 or 22, characterized in that the spring pin (26) is displaceable together with the catch (20) along the axis of rotation (162) of the type wheels (16).

24. Numbering unit (10) according to claim 23, characterized in that one end of the spring pin (26) facing the numbering unit (10) is displaceably mounted in a groove or in a guide groove (28).

25. Numbering unit (10) according to claim 24, characterized in that two guide grooves (28) lying one above the other are implemented, and in that adjacent spring pins (26) are each mounted in a different guide groove (28).

26. Catch (20) for a numbering unit (10) according to any one of claims 1 to 25.

27. Numbering machine comprising a numbering unit (10) according to any one of claims 1 to 25.
